(19) United States
(12) Patent Application Publication
(10) Pub. No.: US 2008/0043883 A1
(43) Pub. Date: Feb. 21, 2008

(54) CHANNEL ESTIMATION USING DYNAMIC-RANGE-LIMITED PILOT SIGNALS

(76) Inventor: James W. McCoy, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/466,007

(22) Filed: Aug. 21, 2006

(51) Int. Cl. H04L 27/06

(52) U.S. Cl. 375/340

(57) ABSTRACT

Methods and systems for channel estimation using dynamic-range-limited pilot signals are provided. In one aspect, a method for communication between a transmitter and a receiver is provided. The method comprises dynamic-range limiting at least one locally generated pilot signal at the at least one receiver to generate a locally generated dynamic-range-limited pilot signal, wherein the at least one locally generated pilot signal is generated in a substantially similar manner as a pilot signal generated at the at least one transmitter.

### CROSS-REFERENCE TO RELATED APPLICATIONS

The following identified U.S. patent applications are relied upon and incorporated by reference in this application:

U.S. patent application Ser. No. 11/346,649, entitled “COMMUNICATION SYSTEM WITH MIMO CHANNEL ESTIMATION USING PEAK-LIMITED PILOT SIGNALS,” filed on Feb. 3, 2006, currently pending; and

U.S. patent application Ser. No. ______, entitled “POWER DE-RATING REDUCTION IN A TRANSMITTER,” filed on the same date herewith, currently pending.

### BACKGROUND OF THE INVENTION

1. Field of the Invention

The present invention relates in general to the field of information processing, and more specifically to communication systems and methods for channel estimation using dynamic-range-limited pilot signals.

2. Related Art

Wireless communication systems typically involve data communication between a subscriber station and a base station. Base stations and subscriber stations can be both transmitting devices and receiving devices when both base stations and subscriber stations are equipped with a receiver and a transmitter. Base stations generally communicate with multiple subscriber stations. Subscriber stations communicate directly with a base station and indirectly, via the base station, with other subscriber stations. The number of base stations depends in part on the geographic area to be served by the wireless communication system. Subscriber systems can be virtually any type of wireless one-way or two-way communication device such as a cellular telephones, wireless equipped computer systems, and wireless personal digital assistants. The signals communicated between base stations and subscriber stations can include data such as voice, electronic mail, and video.

In such wireless communication systems, a transmitting device typically transmits a pilot signal to a receiving device. The receiving device independently synthesizes the pilot signal transmitted by the transmitting device. The receiving device receives a signal r that represents the product of (i) a channel matrix H between the transmitting device and the receiving device and (ii) the pilot signal yₚ(n) plus noise η, i.e. r=Hyₚ(n)+η. The synthesized, pilot signal can then be used by a channel estimator to determine an estimated channel matrix Ĥ. Such methods and systems, however, provide a poor estimate of the channel matrix. This is because conventionally, peak limiting techniques have been applied only to the input signal x by the transmitting device. However, in the channel estimation process a peak-limited pilot sequence xₚ is used to estimate the channel matrix Ĥ. The resulting estimated channel matrix Ĥ is, thus, based upon inaccurate data.

Thus, there is a need for methods and systems that provide a better estimate of the channel matrix.

### BRIEF DESCRIPTION OF THE DRAWINGS

The present invention is illustrated by way of examples and not limited by the accompanying exemplary figures, in which, where appropriate, like references indicate similar elements, in which:

FIG. 1 shows a wireless communication system with a transmitting device and a receiving device communicating via a channel;

FIG. 2 shows a flow chart for an exemplary method for transmitting a signal;

FIG. 3 shows a flow chart for an exemplary method for receiving a signal; and

FIG. 4 shows a wireless communication system with multiple subscriber stations and base stations.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION OF THE EMBODIMENTS

Consistent with embodiments of the invention, methods and systems for channel estimation using dynamic-range-limited pilot signals are provided. In one aspect, a method for communication between a transmitter and a receiver is provided. The method comprises dynamic-range limiting at least one locally generated pilot signal at the at least one receiver to generate a locally generated dynamic-range-limited pilot signal, wherein the at least one locally generated pilot signal is generated in a substantially similar manner as a pilot signal generated at the at least one transmitter.

In another aspect, a receiver for communication with at least one transmitter is provided. The receiver comprises a dynamic-range limiter for limiting at least one locally generated pilot signal at the receiver to generate a dynamic-range-limited pilot signal, wherein the at least one locally generated pilot signal is generated in a substantially similar manner as a pilot signal generated at the at least one transmitter. The receiver further comprises a channel estimator for generating an estimated channel matrix based on at least the dynamic-range-limited pilot signal.

In yet another aspect, a receiver for communication with another transmitter is provided. The receiver comprises a dynamic-range limiter for limiting at least one locally generated pilot signal at the receiver to generate a dynamic-range-limited pilot signal, wherein the at least one locally generated pilot signal is generated in a substantially similar manner as a pilot signal generated at the at least one transmitter. The receiver further comprises a radio frequency demodulator for demodulating a signal received using an antenna and for generating a demodulated signal. The receiver further comprises a de-multiplexer for de-multiplexing the demodulated signal. The receiver further comprises a channel estimator for determining a detector matrix and for determining an estimated channel matrix based at least on the detector matrix and the estimated channel matrix.

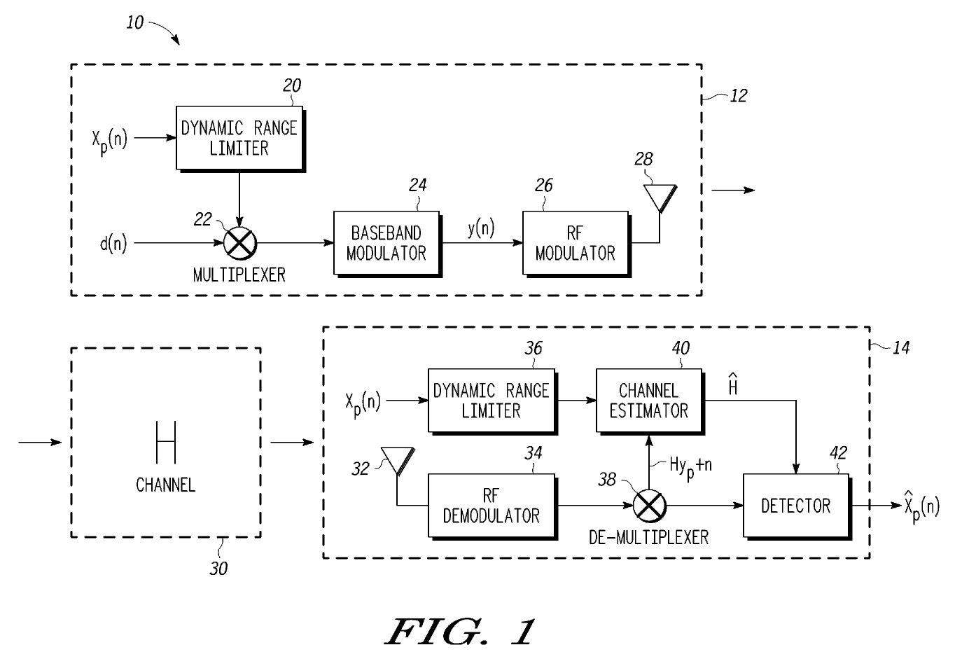

FIG. 1 depicts a communication system 10 with a transmitter 12, which may be a subscriber station and a receiver 14, which may be a base station. Communication system 10 can include other transmitters and receivers. Subscriber station may communicate with a base station via channel 30. Thus, a signal transmitted by transmitter 12 may travel via air and be received by receiver 14. Channel 30 is an abstraction related to the wireless channel via which transmitter 12 and receiver 14 may communicate. Although for ease of description, FIG. 1 identifies communication system 10 as including a transmitter 12 and a receiver 14 communicating with each other via channel 30, communication system 10 may include additional components. Receiver 12 and transmitter 14 may be implemented using any combination of hardware, software, firmware, and/or other types of components. Additionally, the terms subscriber station and base station are used merely to explain the principles of the embodiments and are not intended to be limiting. Indeed, embodiments consistent with the various aspects of the invention may be used in communication environments comprising of other components, such as switching centers etc.

Referring still to FIG. 1, by way of example, transmitter 12 may include: (1) a dynamic range limiter 20, (2) a multiplexer 22, (3) a baseband modulator 24, (4) a radio frequency (RF) modulator 26, and (5) an antenna 28. Although FIG. 1 shows a specific number of components arranged in a specific manner, transmitter 12 may include additional or fewer components, arranged differently. Transmitter 12 may use a pilot sequence vector xₚ to allow the receiving receiver 14 to determine an estimate of the channel matrix H. The content of each sample xₚ(n) of the pilot sequence xₚ is a matter of design choice. In one embodiment, the pilot sequence xₚ may be generalized chirp like (GCL) sequence, such as a constant-amplitude, zero autocorrelation (CAZAC) sequence. The transmitter may transmit a dynamic-range-limited signal yₚ(n)′ to receiver 14. By way of example, dynamic-range-limiter 20 may be implemented using the techniques described in a related pending application, U.S. patent application Ser. No. ______, entitled “POWER DE-RATING REDUCTION IN A TRANSMITTER,” filed on the same date herewith, currently pending. Multiplexer 20 may be used to multiplex the dynamic-range-limited pilot signal and an input signal d(n). Input signal d(n) may be any stream of symbols carrying information, such as data, audio, video, or any other type of information. Baseband modulator 24 may modulate a signal received from multiplexer 22. By way of example, baseband modulator 24 may modulate the signal received at its input using modulation techniques, such as SC-FDMA, OFDMA, or any other suitable modulation technique. Baseband modulated signal y(n) may be processed by RF modulator 26 to generate a signal that may be transmitted via antenna 28. Antenna 28 may be a single antenna or multiple antennas.

With continuing reference to FIG. 1, receiver 14 may include: (1) an antenna 32, (2) a RF demodulator, (3) a dynamic range limiter, (4) a de-multiplexer 38, (5) a channel estimator 40, and (6) a detector 42. Although FIG. 1 shows a specific number of components arranged in a specific manner, receiver 14 may include additional or fewer components, arranged differently. Antenna 32 may be used to receive a signal transmitted by transmitter 12. Receiver may receive a signal r via antenna 32. As shown in FIG. 1, the signal transmitted from transmitter 12 may pass through channel 30, which may introduce noise. The received signal r represents the dynamic-range-limited pilot signal yₚ′ as modified by the channel matrix H and noise n, such that received signal r equals the product of the channel matrix H and the dynamic-range-limited pilot signal yₚ(n)′ plus noise, i.e. r=Hyₚ(n)′+η. The noise vector η is a vector representing noise added by, for example, random vibration of electrons in antenna 32. In case, multiple antennas are used, noise vector η may have several elements corresponding to the multiple antennas. The channel matrix H represents a channel gain between antenna 28 and antenna 32. In case, antenna 28 is configured as an array comprising k antennas and antenna array 32 is configured as an array comprising m antennas, the channel matrix H can be represented by a k×m matrix of complex coefficients. The coefficients of the channel matrix H depend, at least in part, on the geometry and material composition of signal reflective objects.

The received signal may be processed by RF demodulator 34, which may generate a baseband signal, for example. The baseband signal may be fed to a de-multiplexer. Pilot signal xp(n) may be generated in receiver 14 and dynamic range limiter 36 may be used to generate a dynamic-range-limited pilot signal. As part of this process, the pilot signal may be peak limited, null limited, or peak and null limited. Any peak limiting technique used to decrease the peak-to-average ratio of a signal, while attempting to minimize distortion and increase power efficiency, may be used. By way of example, tone reservation techniques, such as is described in J. Tellado-Mourelo, Peak to Average Power Reduction for Multicarrier Modulation, Ph.D. dissertation, Stanford University, Stanford, Calif., September 1999 (referred to herein as Tellado), which is incorporated by reference herein in its entirety, may be used. Thus, for example, a peak limiter provided as part of the dynamic range limiter 36 may be used to peak limit the first through k^{th} elements of a pilot signal and generate a peak limited transmission signal y(n)′ for each of the samples x(n) of pilot sequence x. Transmitter 12 may then transmit transmission signal y(n)′ to receiver 14 and repeat the transmission for each of the transmission signal samples y(n)′. In at least one embodiment, peak limiting may be performed serially on each of samples y(n) using a processor executing a peak limiting algorithm. By way of example, dynamic range limiting techniques described in a related pending application, U.S. patent application Ser. No. ______, entitled “POWER DE-RATING REDUCTION IN A TRANSMITTER,” filed on the same date herewith, currently pending, may also be used.

The output of dynamic range limiter 36 and de-multiplexer 38 may be coupled to an input of a channel estimator 40. Channel estimator 40 determines an estimated channel matrix Ĥ. Any conventional or non-conventional methods may be used to determine the elements of the estimated channel matrix Ĥ using the known pilot sequence xₚ(n). Once the estimated channel matrix Ĥ is known, receiver 14 may use a detector 42 to detect future received signals r=Hyₚ(n)′+η. Since the channel matrix H can change over time and as the location of the transmitter 12 changes, the process used to determine the estimated channel matrix Ĥ can be repeated as desired. Additionally, the process used to determine the estimated channel matrix Ĥ can be repeated as desired can be reversed with the receiver 14 becoming the transmitting device and the transmitter 12 becoming the receiving device.

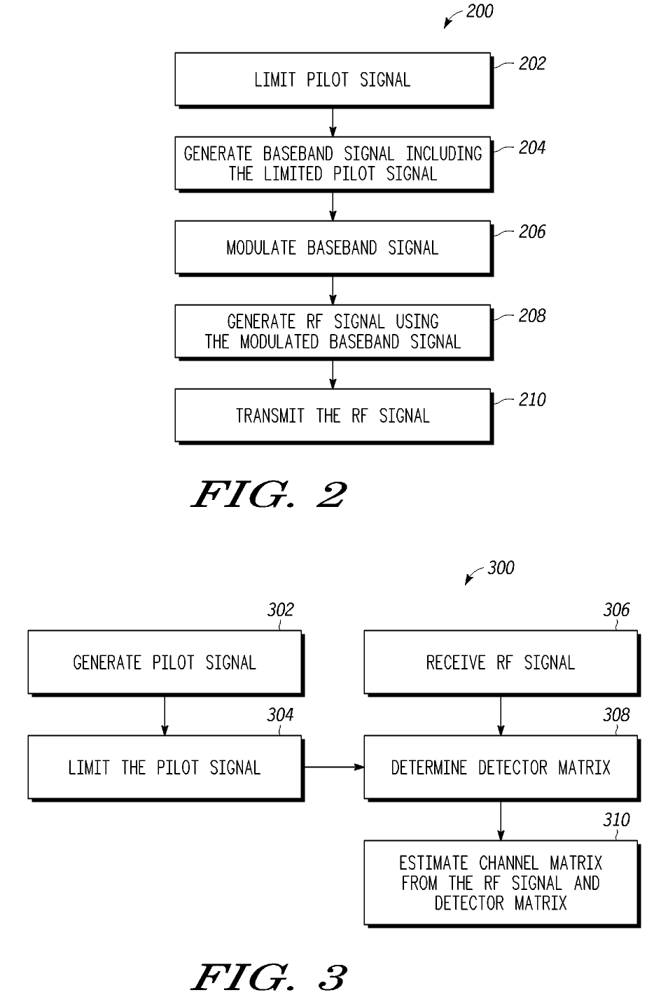

FIG. 2 shows a flowchart 200 for an exemplary method for transmitting an RF signal consistent with embodiments of the invention. By way of example, various components of transmitter 12 may perform each of the steps associated with this method. In step 202, a pilot signal xₚ(n) generated at transmitter 12 may be dynamic-range-limited. By way of example, dynamic range limiter 20 may limit the pilot signal. As explained above, the pilot signal xₚ(n) may be range limited, in that it may be peak limited, null limited, or both. By way of example, dynamic range limiting techniques described in a related pending application, U.S. patent application Ser. No. ______, entitled “POWER DE-RATING REDUCTION IN A TRANSMITTER,” filed on the same date herewith, currently pending, may also be used.

With continued reference to FIG. 2, in step 204, a baseband signal including the limited pilot signal may be generated. By way of example, as part of this step, an input signal d(n) may be mixed using multiplexer 22 with the dynamic-range-limited pilot signal. Input signal d(n) may correspond to a symbol stream carrying information, for example. In step 206, the baseband signal may be modulated. By way of example, baseband modulator 24 may modulate the baseband signal. As explained above with respect to FIG. 1, baseband modulator 24 may modulate the signal received at its input using modulation techniques, such as SC-FDMA, OFDMA, or any other suitable modulation technique.

Referring still to FIG. 2, in step 208, an RF signal may be generated using the baseband signal generated in step 206. By way of example, baseband modulated signal y(n) may be processed by RF modulator 26 to generate a signal for transmission by transmitter 12. In step 210, the signal may be transmitted via antenna 28. Antenna 28 may be a single antenna or multiple antennas. Although specific components are discussed for performing various steps of the method for transmitting the RF signal, these components may be combined or distributed in various ways.

FIG. 3 shows a flowchart 300 for an exemplary method for receiving an RF signal consistent with embodiments of the invention. By way of example, various components of receiver 14 may perform each of the steps associated with this method. In step 302, a pilot signal xₚ(n) may be generated at receiver 14. In step 304, the generated pilot signal may be dynamic-range-limited. By way of example, dynamic range limiter 36 may limit the pilot signal. As explained above, the pilot signal xₚ(n) may be range limited, in that it may be peak limited, null limited, or both. In at least one embodiment, dynamic-range limiter may use the same or an equivalent dynamic range limiting technique, such as tone reservation, as used by dynamic-range limiter 20. By using similar or same dynamic-range limiting techniques receiver 14, in effect, generates a synthesized version of the dynamic-range-limited pilot signal.

In step 306, an RF signal may be received by receive r14. By way of example, receiver 14 may receive the RF signal, transmitted by transmitter 12, for example, via antenna 32. The signal actually received by receiver 14, signal r, is a function of the transmitted, peak limited pilot signal yₚ(n)′, the channel matrix H and antenna generated noise η such that r=Hyₚ(n)′+η, where y(n)′=yₚ(n)′. The received RF signal may then be processed by RF demodulator 34 and inputted to a de-multiplexer 38.

In step 308, a detector matrix is determined. By way of example, channel estimator 40 determines a detector matrix D. The detector matrix D incorporates the synthesized, dynamic-range-limited pilot signal yₚ(n)′ from dynamic range limiter 36. In at least one embodiment, the detector matrix D is derived in accordance with Equation [1]:

D=(y′ₚ^{H}(n)R_{HH}y′ₚ(n)+σₙ²I)⁻¹·y′ₚ^{H}(n)R_{HH} [1],

where yₚ(n)′^{H} is a hermitian vector of the synthesized, peak-limited pilot signal yₚ(n)′ determined in operation 304, R_{HH} is an auto correlation matrix of the channel, σ is the variance of noise η introduced as a result of transmission via channel H 30, and I is an identity matrix.

In step 310, a channel matrix is estimated based on the received RF signal and the detector matrix generated in step 308, for example. Channel estimator 40 determines an estimated channel matrix Ĥ (also referred to as the “estimated channel Ĥ”) using the received signal r and the detector matrix D in accordance with Equation [2]:

rD=Ĥ [2].

Since the channel matrix H can change over time and as the location of the transmitter 12 changes, processes 200 and 300 can be repeated as desired to determine updated estimates of channel matrix H. Additionally, processes 200 and 300 can be reversed with the receiver 14 becoming the transmitting device and the transmitter 12 becoming the receiving device. Once the estimated channel matrix Ĥ is determined in step 310, detector 42 uses the estimated channel matrix Ĥ to decode future received signals r=Hy′+η in accordance with decoding technology. The decoding technology is a matter of design choice and can, for example, be any conventional decoding technology.

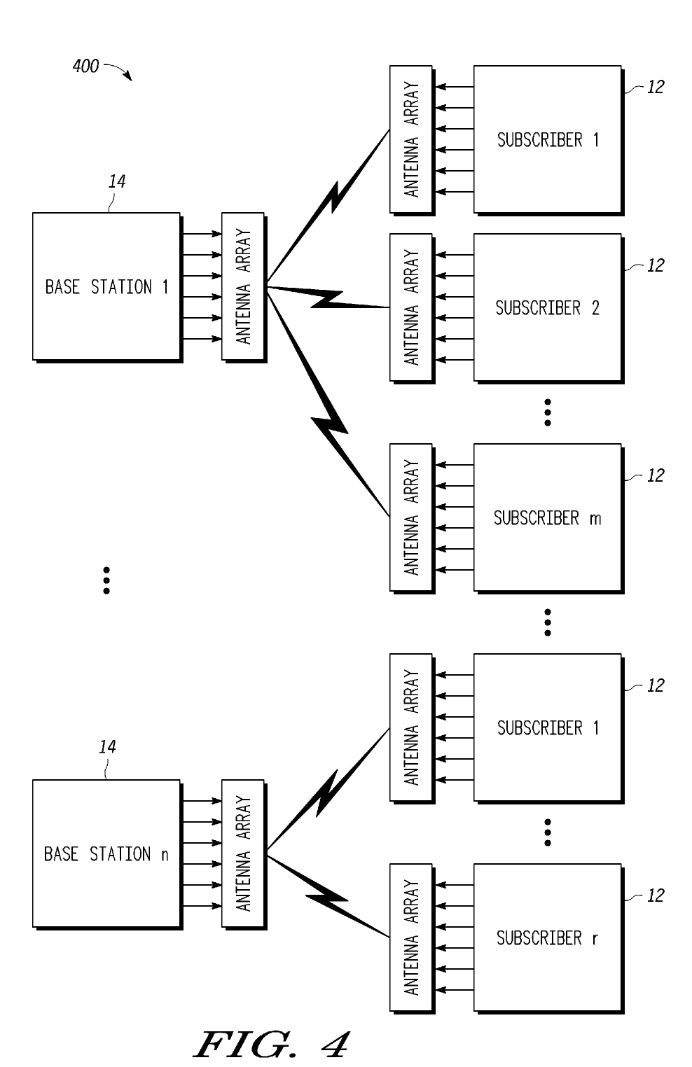

FIG. 4 shows a wireless communication system 400 with multiple subscriber stations 12 (1-m and 1-r), where m and r are respective integers representing the number of respective subscriber stations and multiple base stations (1-n), where n is the number of base stations. In at least one embodiment, at least one of subscriber stations 12.1 and 12.M may include the capabilities of subscriber station 12 and at least one of base stations 14.1 to 14.N may include the capabilities of base station 14. Although FIG. 4 shows a specific number and arrangement of subscriber stations and base stations, there may be additional or fewer of these stations and they may be arranged differently. Additionally, wireless communication system 400 may include other components, such as mobile station controllers, etc.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for communication between at least one transmitter and at least one receiver, the method comprising:
dynamic-range limiting at least one locally generated pilot signal at the at least one receiver to generate a locally generated dynamic-range-limited pilot signal, wherein the at least one locally generated pilot signal is generated in a substantially similar manner as a pilot signal generated at the at least one transmitter.

2. The method of claim 1, wherein the locally generated dynamic-range-limited signal is limited in a substantially similar manner as a dynamic-range-limited pilot signal at the transmitter.

3. The method of claim 1 wherein the receiver is a part of a device selected from a group consisting of cellular telephones, wireless equipped computer systems, and wireless personal digital assistants.

4. The method of claim 1 further comprising:
receiving a radio frequency signal (r), wherein radio frequency signal (r) is a vector computed using an equation: r=Hyₚ(n)′+η, wherein H is a matrix representing a channel, yₚ(n)′ is a vector representing a dynamic-range-limited pilot signal transmitted by the at least one transmitter, and η is a vector representing noise.

5. The method of claim 1 further comprising:
determining a detector matrix D that incorporates the locally generated dynamic-range-limited pilot signal.

6. The method of claim 5 further comprising:
estimating a channel matrix based on at least the detector matrix D.

7. The method of claim 5 further comprising:
deriving the detector matrix D in accordance with:
D=(y′ₚ^{H}(n)R_{HH}y′ₚ(n)+σₙ²I)⁻¹·y′ₚ^{H}(n)R_{HH}
wherein yₚ(n)′^{H} is a hermitian vector of the locally-generated dynamic-range-limited pilot signal, R_{HH} is an auto correlation matrix of the channel, σ is the variance of noise η introduced as a result of transmission via a channel between the at least one receiver and the at least one transmitter, and I is an identity matrix.

8. A receiver for communication with at least one transmitter, the receiver comprising:
a dynamic-range limiter for limiting at least one locally generated pilot signal at the receiver to generate a dynamic-range-limited pilot signal, wherein the at least one locally generated pilot signal is generated in a substantially similar manner as a pilot signal generated at the at least one transmitter; and
a channel estimator for generating an estimated channel matrix based on at least the dynamic-range-limited pilot signal.

9. The receiver of claim 8 further comprising:
a detector for decoding future signals received by the receiver based on the estimated channel matrix.

10. The receiver of claim 8, wherein the channel estimator generates the estimated channel matrix based on at least the detector matrix D.

11. The receiver of claim 10 further comprising at least one antenna for receiving a radio frequency signal (r), wherein radio frequency signal (r) is a vector computed using an equation: r=Hyₚ(n)′+η, wherein H is a matrix representing a channel, yₚ(n)′ is a vector representing a dynamic-range-limited pilot signal transmitted by the at least one transmitter, and η is a vector representing noise.

12. The receiver of claim 8, wherein the receiver is a part of a device selected from a group consisting of cellular telephones, wireless equipped computer systems, and wireless personal digital assistants.

13. The receiver of claim 9, wherein the channel estimator derives the detector matrix D in accordance with::
D=(y′ₚ^{H}(n)R_{HH}y′ₚ(n)+σₙ²I)⁻¹·y′ₚ^{H}(n)R_{HH}
wherein yₚ(n)′^{H} is a hermitian vector of the locally-generated dynamic-range-limited pilot signal, R_{HH} is an auto correlation matrix of the channel, σ is the variance of noise η introduced as a result of transmission via a channel between the at least one receiver and the at least one transmitter, and I is an identity matrix.

14. The receiver of claim 8, wherein the dynamic-range limiter limits the at least one locally generated pilot signal using a tone reservation peak-limiting technique.

15. The receiver of claim 8 further comprising:
a radio a radio frequency demodulator for demodulating a signal received using an antenna and for generating a demodulated signal; and
a de-multiplexer for de-multiplexing the demodulated signal.

16. A receiver for communication with at least one transmitter, the receiver comprising:
a dynamic-range limiter for limiting at least one locally generated pilot signal at the receiver to generate a dynamic-range-limited pilot signal, wherein the at least one locally generated pilot signal is generated in a substantially similar manner as a pilot signal generated at the at least one transmitter;
a radio frequency demodulator for demodulating a signal received using an antenna and for generating a demodulated signal;
a de-multiplexer for de-multiplexing the demodulated signal;
a channel estimator for determining a detector matrix and for determining an estimated channel matrix based at least on the detector matrix and the estimated channel matrix.

17. The receiver of claim 16 further comprising a detector for decoding future signals received by the receiver based on the estimated channel matrix.

18. The receiver of claim 16, wherein the dynamic-range limiter limits the at least one locally generated pilot signal using a tone reservation peak-limiting technique.
